(19) United States
(12) Patent Application Publication
(10) Pub. No.: US 2016/0328962 A1
(43) Pub. Date: Nov. 10, 2016

(54) APPARATUS AND METHOD TO INFORM DRIVER OF LOCAL SPEED LIMIT

(71) Applicant: John C. McMahon, Tonganoxie, KS (US)

(72) Inventor: John C. McMahon, Tonganoxie, KS (US)

(21) Appl. No.: 15/144,354

(22) Filed: May 2, 2016

Related U.S. Application Data
(60) Provisional application No. 62/156,636, filed on May 4, 2015.

(51) Int. Cl. G08G 1/052; B60W 50/14; B60W 40/105; G08G 1/0962; G08G 1/0967

(52) U.S. Cl. CPC G08G 1/052; G08G 1/09623; G08G 1/0967; B60W 40/105; B60W 50/14; B60W 2050/143; B60W 2050/146

(57) ABSTRACT

An apparatus adapted for use in a vehicle for obtaining the speed limit of the path being traversed by the vehicle and comparing the speed of the vehicle to the speed limit; thereafter, indicating to a driver of the vehicle when the speed limit has been exceeded.

### CROSS-REFERENCE TO RELATED APPLICATIONS

This application claims the benefit of U.S. Provisional Patent Application Ser. No. 62/156,636, filed May 4, 2015 and incorporated by reference herein.

### BACKGROUND OF THE INVENTION

When driving on roads it is important to obey the speed limits associated with the road being traversed. However, the speed limits vary at different locations along the road or may vary when transferring from one road to another. The speed limit may also be changed without notice to a driver who thinks that they know the speed limit. If the driver is not familiar with a particular road or if the limits are changed, the driver may not know the speed limits along his path of travel or may miss signage changing the speed limit.

### SUMMARY OF THE INVENTION

An apparatus is provided for identifying the appropriate speed limit for a portion of a road being transversed and conveying that information to a driver.

In order to obtain the information, some signal would normally be transmitted that would include the speed limit for a stretch of highway and for how long a distance that speed limit would be in effect. The method of transmission may be located on speed limit signage which would require cooperation with state and federal authorities that oversee such signage. Alternatively, the signal may come from a global positioning system onto which comprehensive speed limit data would be entered and would then transmit such data in conjunction with utilizing the global positioning system (GPS) to identify the location and directional vector of a vehicle being driven. Further, alternatively, the data could be manually inserted by a driver while progressing along a particular path each time they encounter speed limit signage. Unfortunately, the manual insert alternative provides data only for routes previously traveled. The data may also be available from a stored database available by computer or phone.

In the vehicle, the transmitted speed data or stored speed data is analyzed by a computer or the like and compared to the location, speed and direction of travel of the vehicle in a receiver. Again, this information may come from a GPS system or may be manually entered, at least at first with a route, and then followed by monitoring speed, time and the like. The receiver utilizes the speed limit information and compares this to a vehicle location and direction of travel. The receiver then provides the driver with an indication of the speed limit that is appropriate. The speed may be provided on a visual display and/or a verbal output. Preferably, the receiver is mounted permanently on the dashboard or it may be secured there by materials, such as adhesive, to the dashboard. The receiver may be powered by connection with the electrical system of the vehicle or may be self powered by batteries or the like. The receiver may also cooperate with the speed indicator of the vehicle or a GPS system to determine the actual speed of the vehicle. The receiver can then compare the actual speed to the speed limit and provide the driver with a flashing indicator or audio signal that the speed limit is being exceeded.

### Objects and Advantages of the Invention

Various objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a block diagram of a receiver for comparing actual speed to a speed limit while driving in accordance with the invention.

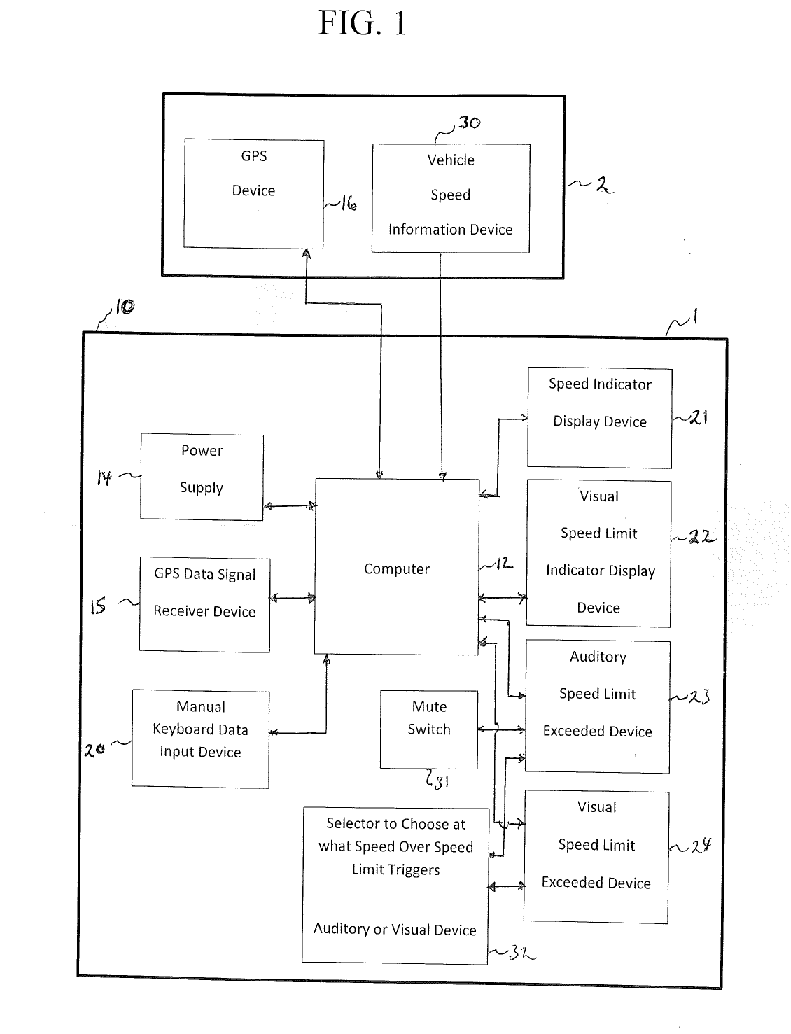

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The reference numeral 1 generally indicates a speed limit indicating apparatus in accordance with the invention. The apparatus 1 is normally utilized in conjunction with a mobile vehicle 2 that is adapted to be driven along the various highways and roads that have an associated speed limit which may vary frequently over the distance traveled or may vary over time due to changes.

The apparatus 1 includes a case 10 that is preferably independently mountable in the vehicle 2; however, it is foreseen that the case may be mounted as an integral portion of the vehicle 2.

The apparatus 1 includes a control computer 12 which is a conventional computer with sufficient capacity for the operation to be performed. The apparatus 1 has a power supply 14 that is preferably an independent battery supply or the like; however, it is foreseen that the power supply 14 may be supplied by joining with the power supply of the vehicle 2. The apparatus 1 preferably also includes a global positioning system 15 (GPS) that operably identifies the position of the vehicle 2 on the surface of the earth. Most vehicles 2 today include a GPS device 16 and it is foreseen that the apparatus 1 may join with the vehicle GPS device 16 and utilize the device 16 for data rather than have its own GPS 15.

Preferably, the apparatus also includes an entry keyboard 20 for allowing the entry of speed limit data, a visual speed indicator display 21, a visual speed limit indicator display device 22, an auditor and or visual signal device 23 for announcing visually and/or auditorally device 24 when the limit is exceeded.

The apparatus 1 functions to take in speed limit information from any source available which may include transmissions from the speed limit signage, from satellite transmissions joined with a GPS signal, from computer data storage or any type of storage system, such as a phone, laptop, Ipad, or the like. The data is stored in the computer 12 of the apparatus 1 and compared to actual speed. The actual speed may come from the speed information device or speedometer 30 of the vehicle 2 or by calculation or the like from GPS 15 data.

The actual speed is compared to the speed limit and a signal is transmitted by the computer 12 to the auditory device 23 and visual device 24 to indicate when the speed limit is being exceeded and preferably the excess speed is digitally indicated. The system may be muted if desired by a mute switch 31.

A selector 32 is provided and linked to the auditory device 23 and visual device 24 to allow a driver to select a speed over the speed limit (for example, 2 miles per hour) or zero at which the auditory device 23 is triggered to notify the driver or at which the visual device 24 starts to flash or the like to provide a driver with an alert that the selected speed has been exceeded.

It is to be understood that while certain forms of the present invention have been illustrated and described herein, it is not to be limited to the specific forms or arrangement of parts described and shown.

What is claimed and desired to be secured by Letters Patent is as follows:

1. An apparatus adapted for providing a driver of a vehicle with speed limit information appropriate to a region of a road being transversed by the vehicle comprising:
a) a receiver adapted for use in the vehicle;
b) the receiver including a computer, a data input device and a speed limit display device; the computer cooperating with the data input device to associate the speed limit data for a specific location with vehicle travel and to thereafter transmit a signal to the display device to indicate the speed limit that is thereafter displayed on the display device.

2. The apparatus according to claim 1 wherein the data input device is a GPS operably joined to the computer and including the ability to receive a GPS signal with speed limit data associated with a particular location.

3. The apparatus according to claim 1 wherein the data input device is a manual input system imputed into the computer.

4. The apparatus according to claim 1 wherein the data input device is a receiver that is adapted to receive speed limit data from a transmitter of such speed limit data near the location of the vehicle.

5. The apparatus according to claim 1 wherein:
a) the display device includes a first display that cooperates with the computer to display the speed limit for the specific location.

6. The apparatus according to claim 5 wherein:
a) the display device includes a second display identifying the current speed of the vehicle.

7. The apparatus according to claim 5 wherein:
a) the display device includes an output signal identifying when the actual speed of the vehicle exceeds the speed limit.

8. The apparatus according to claim 7 wherein:
a) the output signal is a flashing light.

9. The apparatus according to claim 7 wherein:
a) the output signal is an audio signal.

10. A method of providing a driver of a vehicle with information regarding speed limit comprising the steps of:
a) providing speed limit data associated with a driving pathway;
b) collecting the speed limit data in a computer system; and comparing such data to a particular location so as to provide a speed limit for the location; and
c) providing a display adapted for use in the vehicle that cooperates with the computer to receive a real time output of the speed limit for the location of the vehicle and to display the output for visual viewing of the driver of the vehicle.

11. The method according to claim 1 including the steps of:
a) utilizing the computer to compare actual speed with the speed limit; and
b) producing an output signal that can be used by the driver to determine when the speed limit has been exceeded.
